(19) United States
(12) Patent Application Publication
(10) Pub. No.: US 2019/0050050 A1
(43) Pub. Date: Feb. 14, 2019

(54) MOBILE DEVICE AND METHOD OF IMPLEMENTING VR DEVICE CONTROLLER USING MOBILE DEVICE

(71) Applicant: LG Electronics Inc., Seoul (KR)

(72) Inventors: Sukchan JUNG, Seoul (KR); Donghoon KIM, Seoul (KR); Goya CHOI, Seoul (KR); Eunkyoung HONG, Seoul (KR)

(21) Appl. No.: 15/853,179

(22) Filed: Dec. 22, 2017

(30) Foreign Application Priority Data
Aug. 10, 2017 (KR) 10-2017-0101491

(51) Int. Cl. G06F 3/01; A63F 13/22; A63F 13/235; G06F 3/0484

(52) U.S. Cl. CPC G06F 3/011; A63F 13/22; A63F 2300/8082; G06F 3/04842; A63F 13/235

(57) ABSTRACT

The present invention relates to a mobile device, a method of implementing a virtual reality (VR) device controller using the mobile device, and a VR display system. According to one embodiment of the present invention, a method driving a virtual reality device (VR device) controller includes the steps of executing a VR application (VR app) for driving a VR device, driving a controller connection processor interlocked with the VR app, selecting either an external controller or a virtual controller as a controller for driving the VR device via the controller connection processor, and if the virtual controller is selected, performing communication with the VR device by generating a data packet corresponding to the selected virtual controller. According to the embodiment of the present invention, since a mobile device is able to provide a virtual controller for driving a VR device, a user is able to more conveniently utilize the VR device.

### CLAIM OF PRIORITY

This application claims the benefit of the Korean Patent Application No. 10-2017-0101491, filed on Aug. 10, 2017, which is hereby incorporated by reference as if fully set forth herein.

### BACKGROUND OF THE INVENTION

### Field of the Invention

The present invention relates to a mobile device, a method of implementing a VR (virtual reality) device controller using the mobile device, and a VR display system.

### Discussion of the Related Art

Recently, with the development of radio communication technology, the use of a compact mobile device (e.g., a smartphone, a tablet, etc.) is increasing. And, the use of various devices implementing VR (virtual reality) or AR (augmented reality) (hereinafter, “AR device” or “VR device”) is also increasing.

In relation to this, there is a drift towards using a VR device of a tethered scheme that connects the VR device and the mobile device with each other via communication. Yet, in order to efficiently drive the VR device using the mobile device, it is necessary to use a controller in general.

FIG. 1 illustrates a legacy general VR display system related to the present invention. The general VR display system includes a VR device 20 including a display means for visually providing VR data and a mobile device 10 providing a program for driving the VR device 20 and/or VR or AR data. The VR device 20 and the mobile device 10 are connected with each other in wired or wirelessly 30. The VR device 20 including the abovementioned configuration is referred to as a tethered scheme VR device.

And, the legacy VR display system can include at least one or more external controllers 41/42 configured to control the drive of the VR device 20. The external controllers 41/42 are connected with the mobile device 10 through a wireless communication means 50 and control the VR device via the mobile device 10.

Yet, when the VR display system is able to use the external controllers 41/42 as a controller only, if the external controllers 41/42 are lost through inattention or the external controllers 41/42 are out of action, it was unable to use the entire VR display system. And, since the external controllers 41/42 of a single fixed type are used, it was unable to provide various controller functions.

### SUMMARY OF THE INVENTION

Accordingly, the present invention is directed to an apparatus and method thereof that substantially obviate one or more problems due to limitations and disadvantages of the related art.

An object of the present invention is to provide a controller of various types to be applied to a VR display system.

Another object of the present invention is to provide a mobile device that enables a user to directly select a controller of various types to be applied to a VR display system.

Another object of the present invention is to implement a virtual controller in a mobile device used for a VR display system.

The other object of the present invention is to provide a mobile device that enables a user to directly select one from among a virtual controller and an external controller used for a VR display system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, according to one embodiment, a method of driving a virtual reality (VR) device controller include the steps of executing a VR app (application) for driving a VR device, driving a controller connection processor interlocked with the VR app, selecting either an external controller or a virtual controller as a controller for driving the VR device via the controller connection processor, and if the virtual controller is selected, performing communication with the VR device by generating a data packet corresponding to the selected virtual controller.

If the external controller is selected, the method can further include the step of controlling the selected external controller to be connected via wireless communication.

The method can further include the step of visually providing information on an available external controller and a virtual controller provided by the controller connection processor.

If the virtual controller is selected, the method can further include the step of providing a virtual controller user manual provided by the controller connection processor.

The controller user manual can be provided in a manner of being overlaid with a background screen.

The controller connection processor can be configured using a controller connection program (controller abstract layer).

The controller connection program (controller abstract layer) includes a virtual controller type storing unit configured to store at least one or more virtual controllers, an interface unit configured to perform a process of establishing a session with the VR app by selecting an interface appropriate for a type of a connected virtual controller, and a packet generating unit configured to generate a data packet according to a protocol appropriate for the type of the connected virtual controller.

The controller connection program (controller abstract layer) can further include a sensor sensing unit configured to collect sensor data appropriate for the type of the connected virtual controller and a touch sensing unit configured to collect an input touch data appropriate for the type of the connected virtual controller.

A VR (virtual reality) display system according to the present invention includes a tethered VR device including a VR display means, a mobile device configured to control a VR display in a manner of being connected with the VR device, and a controller configured to control the VR device to be driven. In this case, the controller includes either a virtual controller provided within the mobile device or an external controller physically separated from the mobile device and the mobile device includes a controller connection processor configured to select either the virtual controller or the external controller as a controller.

According to embodiments of the present invention, since a mobile device provides a virtual controller for driving a virtual reality device, a user is able to more conveniently use the virtual reality device.

According to embodiments of the present invention, since a mobile device provides a function capable of selecting either a virtual controller or an external controller for driving a virtual reality device, a user is able to more conveniently use the virtual reality device.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram for a legacy general virtual reality display system related to the present invention;

FIG. 2 is a diagram for a detail configuration of a mobile device according to an embodiment of the present invention;

FIG. 3 is a flowchart of a method for a mobile device to provide a controller for driving a virtual reality device according to an embodiment of the present invention;

FIG. 4 is a diagram for an example of a screen displayed on a mobile device according to an embodiment of the present invention;

FIG. 5 is a diagram for a different example of a screen displayed on a mobile device according to an embodiment of the present invention;

FIG. 6 is a diagram for a detail configuration of a virtual controller connection processor according to an embodiment of the present invention;

FIGS. 7 and 8 are diagrams for explaining an operation of a virtual controller connection processor according to an embodiment of the present invention;

FIG. 9 is a diagram for a procedure of selecting and executing a virtual controller by a virtual controller connection processor according to an embodiment of the present invention;

FIG. 10 is a diagram for a procedure of selecting and executing a virtual controller by a virtual controller connection processor according to an embodiment of the present invention;

FIGS. 11 and 12 are diagrams for an example of a data format according to a virtual controller when the virtual controller is selected by a virtual controller connection processor according to an embodiment of the present invention.

### DETAILED DESCRIPTION OF THE INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

Mobile devices presented herein may correspond to a common name of electronic devices used by a user while being carried. Examples of such devices include a smartphone, a tablet PC, and the like, by which the present specification may be non-limited.

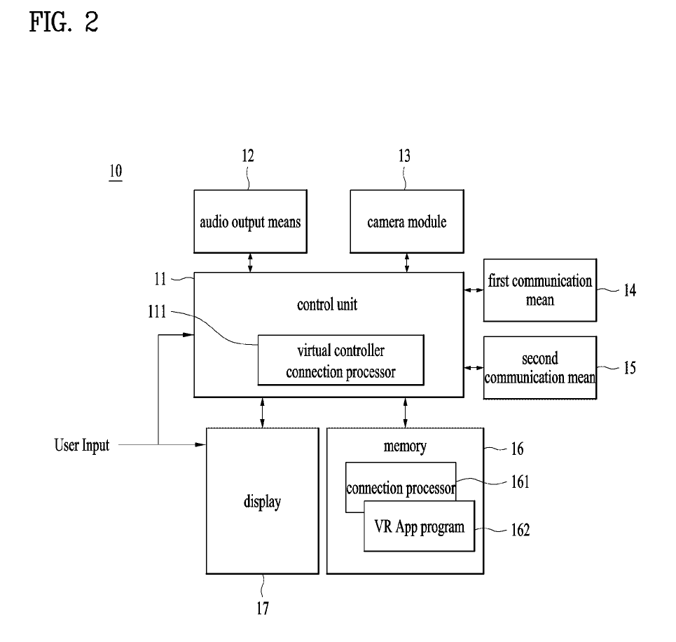

FIG. 2 is a diagram for a detail configuration of a mobile device according to an embodiment of the present invention.

According to one embodiment of the present invention, a mobile device is configured in a manner of including a second communication means 15, a memory 16, a display means 17, and a control unit 11. And, the mobile device of the present invention can further include an audio output means 11, a camera module 12, and a first communication means 14.

The second communication means 15 corresponds to a communication means capable of performing short distance communication with a surrounding device. For example, the second communication means corresponds to a communication means utilizing Bluetooth, WiFi, Zigbee, and the like. In particular, in relation to the embodiment of the present invention, the second communication means 15 is used for performing communication with the abovementioned external controller 41/42. On the other hand, the first communication means 14 corresponds to a means for performing long distance mobile communication. For example, the first communication means may correspond to a communication means utilizing 3G, LTE, 5G, and the like.

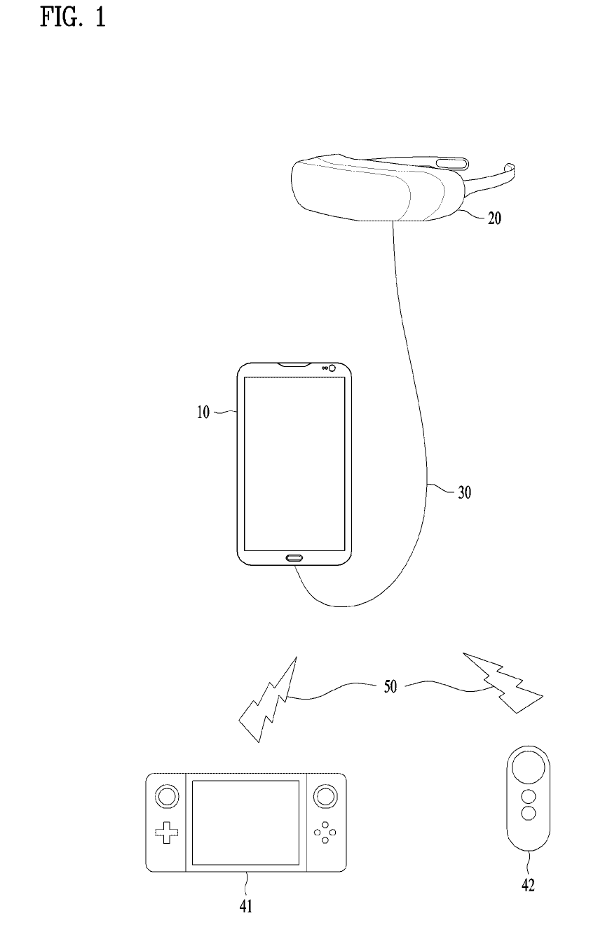

The memory 16 corresponds to a space for storing various programs and data for driving the mobile device. In particular, in relation to the present invention, the memory stores a VR application program (VR app or app) 162 for driving a virtual reality device. The VR app 162 may correspond to contents downloaded from the external or a program configured when the mobile device is firstly manufactured. And, the VR app 162 can be used for a specific VR device only. Or, the VR app 162 can be used as the usage of comprehensively utilizing various VR devices. In particular, in relation to the present invention, the VR app provides the VR device 20 shown in FIG. 1 with a virtual reality data and a function of controlling operations of the VR device 20 (e.g., power on/off, volume up/down, screen brightness adjustment, etc.). Hence, in order to drive the tethered VR device 20, it is necessary to preferentially execute the VR app 162 installed in the mobile device 10.

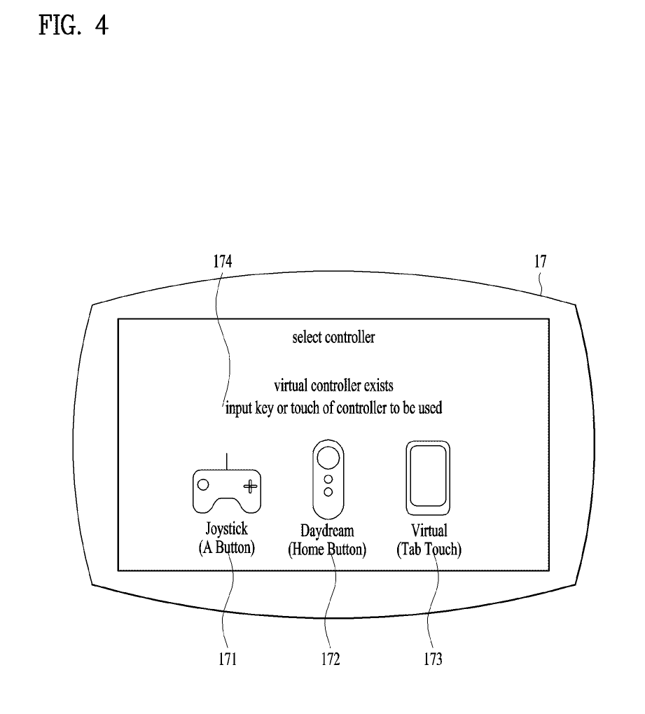

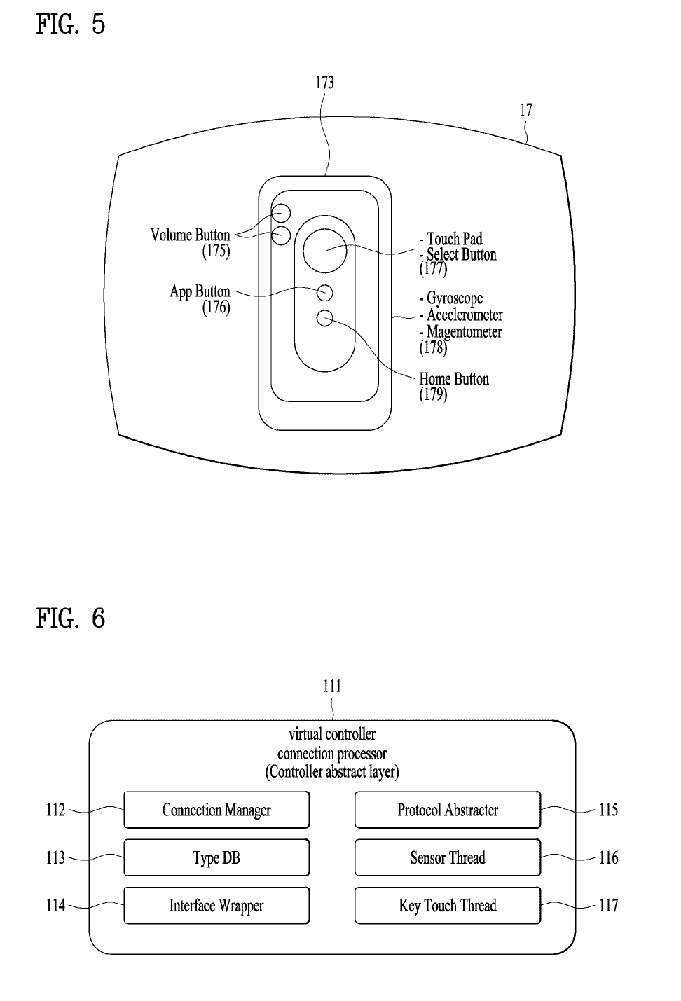

The display means 17 provides visual information to a user of the mobile device 10. In particular, in relation to the present invention, the display means 17 can provide a guide screen for selecting a VR device controller to the user. Regarding this, it shall be described in detail with reference to FIGS. 4 and 5.

The control unit 11 performs a function of controlling operations of configuration elements that construct the mobile device 11. In particular, in relation to the present invention, the control unit 11 can further include a virtual controller connection processor 111. In relation to this, a virtual controller may correspond to all virtualized controllers provided to the mobile device 10 to drive the VR device 20. Unlike the external controller 41/42 shown in FIG. 1, the virtual controller does not need to have a communication connection connected by the short distance second communication means 15 with the mobile device 10.

The display means 17 and the control unit 11 can receive a direct command (user input) inputted by a user. Although it is not depicted in FIG. 2, the mobile device 10 may have various user input buttons on an outer frame that configures an external shape of the mobile device. Hence, a user can directly receive a user command for controlling functions (e.g., power on/off, volume up/down, screen brightness adjustment, etc.) of the mobile device 10 via the buttons.

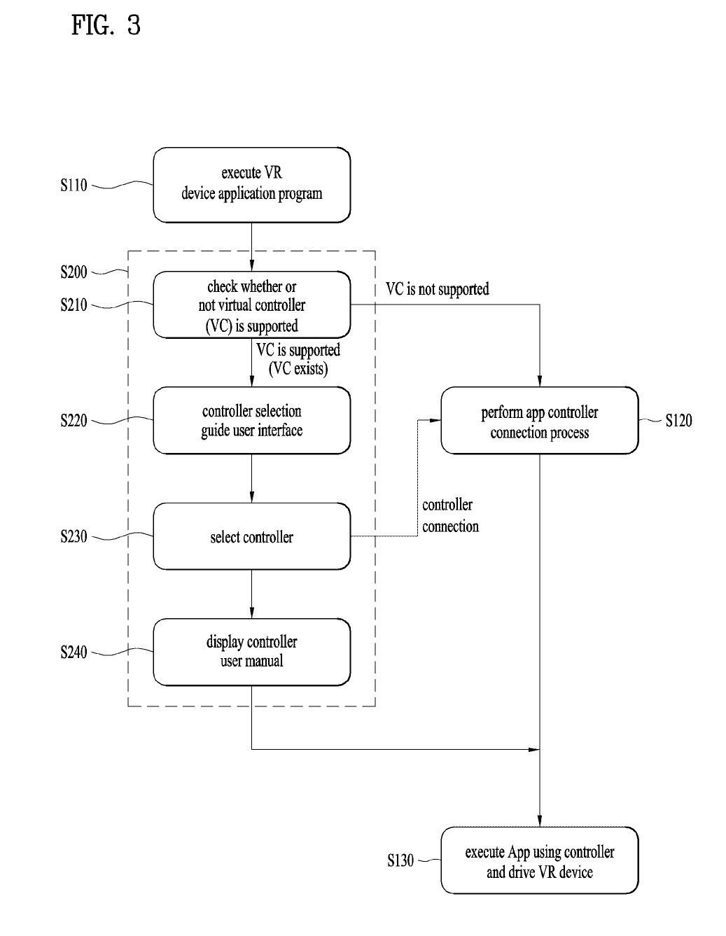

FIG. 3 is a flowchart of a method for the control unit 11 of the mobile device to provide a controller for driving the virtual reality device 20 according to an embodiment of the present invention.

First of all, the control unit executes the aforementioned VR app 162 in the mobile device [S110]. The VR app 162 may use a previously used VR app as it is. It is not necessary to additionally add or modify the previously used VR app for the embodiment of the present invention. In particular, the present invention can be implemented while maintaining compatibility with a legacy VR app 162.

If the VR app 162 is executed, the virtual controller connection processor 111 of the control unit 11 performs a controller connection operation for the VR device 20 [S200]. The step S200 can be configured by detailed steps described in the following.

First of all, the virtual controller connection processor checks whether or not the mobile device 10 supports a virtual controller [S210]. If the virtual controller is not supported in the mobile device 10 (VC not supported), the virtual controller connection processor moves to a controller connection process supported by the VR app 162 [S120]. In the step S120, a controller connection scheme (e.g., connecting an external controller) supported by the VR app is performed.

In the step S210, if the mobile device 10 supports a virtual controller (VC is supported, VC exists), the virtual controller connection processor 111 provides a controller selection guide screen via the display means 17 [S220]. FIG. 4 shows an example of a controller selection menu screen provided by the display means 17 in the step S220. If one or more virtual controllers 173 are provided to the mobile device 10, the virtual controllers are displayed on a display screen together with external controllers 171/172. And, a guide phrase 174 can also be displayed on the display screen to indicate the existence of the virtual controllers. Although it is not depicted in FIG. 4, if a plurality of virtual controllers are supported by the mobile device 10, a plurality of the supported virtual controllers are provided to the display screen only and a user can select a virtual controller from among a plurality of the virtual controllers using a VR device controller.

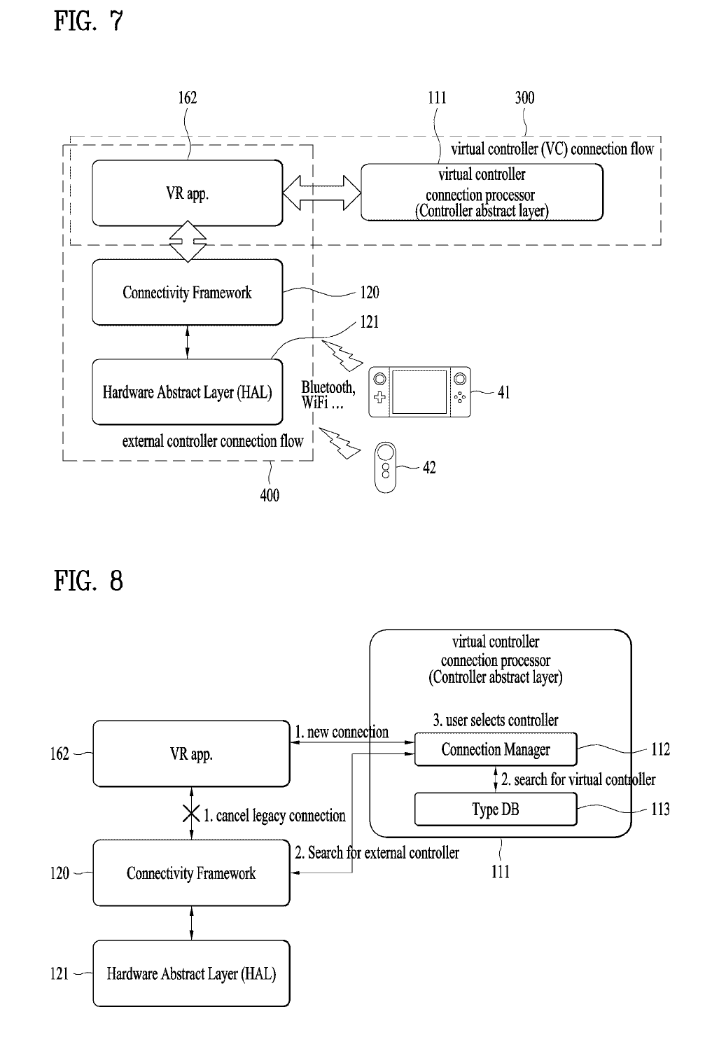

If a user selects a specific VR device controller via the step S220 [S230], the selected controller is connected with the controller connection process [S120] to make the selected controller to be interlocked with the controller connection process. Regarding this, it shall be described later with reference to FIGS. 6 to 12.

Subsequently, a user manual of the selected controller can be provided to the display screen [S240]. FIG. 5 shows an example of a user selection controller visually provided to the display means 17. For example, if a user selects a virtual controller 173 in FIG. 4, positions of a volume button 175, an app button 176, a touchpad selection button 177, and a home button 179 are provided as a user manual of the selected controller. And, positions of sensing means such as a gyroscope, an accelerometer, and a magnetometer are also provided as the manual.

The user manual can be displayed in a manner of being overlaid with a background screen of a legacy mobile device 10 for user convenience. In particular, when the user manual is fade-in and fade-out, the user manual can be configured to be overlaid with the background screen.

FIG. 6 is a diagram for a detail configuration of the virtual controller connection processor 111 according to an embodiment of the present invention. Referring to FIG. 6, the virtual controller connection processor 111 according to the present invention is embedded in the mobile device 10. The virtual controller connection processor can be configured by either a hardware program or a software program.

In particular, if the virtual controller connection processor 111 is implemented using a software program, the virtual controller connection processor can be configured by a controller connection program (controller abstract layer). The controller connection program (controller abstract layer) includes a connection manager 112, a controller type storing unit (type DB) 113, an interface unit (interface wrapper) 116, a packet generating unit (protocol abstracter) 115, a sensor sensing unit (sensor thread) 116, and a touch sensing unit (key touch thread) 117.

The controller type storing unit (type DB) 113 stores at least one virtual controller type. The virtual controller type is not restricted to a single type and can be configured by various types.

The interface unit (interface wrapper) 116 selects an interface matched with a virtual controller type connected with a VR app 162 and performs a session connection process with the VR app 162.

It is able to receive sensor data and touch input data matched with the connected virtual controller type via the sensor sensing unit (sensor thread) 116 and the touch sensing unit 117.

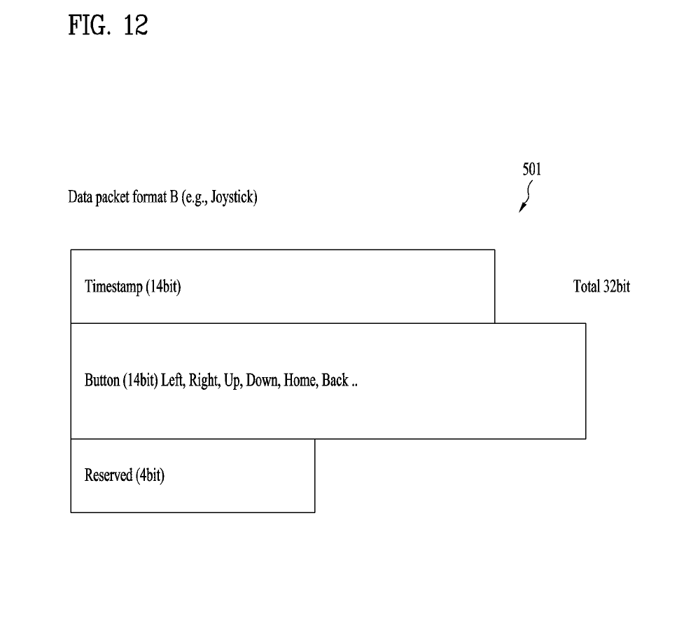

The packet generating unit (protocol abstracter) 115 generates a data packet according to a protocol matched with the connected virtual controller type. Data collected via the sensor sensing unit (sensor thread) 116 and the touch sensing unit 117 are configured according to a specific format in the data packet. In relation to this, FIGS. 11 and 12 show an example of a data packet format according to the selected virtual controller type. For example, FIG. 11 shows a data packet format applicable to a virtual controller type (e.g., “Daydream”) of a specific scheme. Referring to FIG. 11, the data packet format can be transmitted in a manner of including a value and a button sensed by the gyroscope, the accelerometer, or the magnetometer, or a touch input value. FIG. 12 shows a data packet format applicable to a virtual controller type (e.g., “Joystick”) of a different scheme. Referring to FIG. 12, the data packet format can be transmitted in a manner of including the aforementioned button input value.

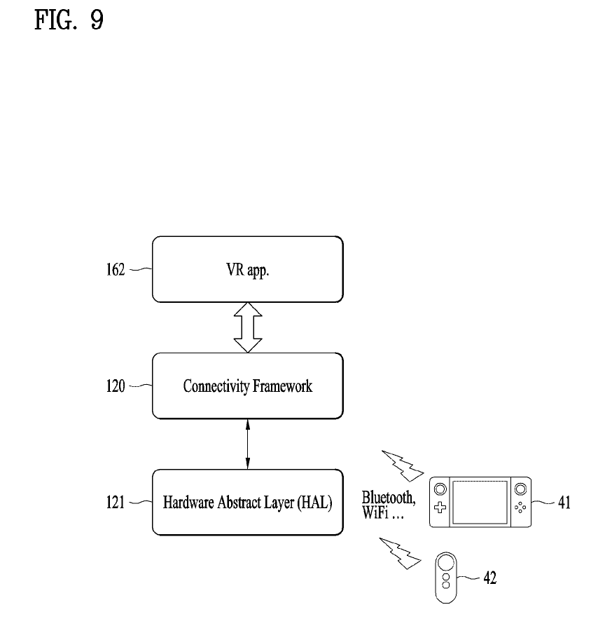

FIGS. 7 and 8 are diagrams for explaining an operation between the virtual controller connection processor 111 and the VR app 162 according to an embodiment of the present invention. In particular, FIG. 7 shows an overall system configuration and FIG. 8 shows an operation of the virtual controller connection processor 111 when the VR app 162 is executed.

Referring to FIG. 7, the VR app 162 respectively performs a legacy external controller 41/42 connection process 400 and a virtual controller connection process 300 via the virtual controller connection processor 111. In relation to this, referring to FIG. 7, if the legacy VR app 162 is executed, the process for interworking with an external controller is performed. For example, in case of a VR app 162 of Android scheme, a state capable of performing communication with the external controller 41/42 is maintained via a connectivity framework 120 and a hardware connection program (hardware abstract layer) 121.

On the contrary, referring to FIG. 8, if the VR app 162 is executed, a new connection is established with the virtual controller connection processor 111 of the present invention while the connection connected with the legacy connectivity framework 120 is cancelled (1. Legacy connection is cancelled) (1. New connection).

The virtual controller connection processor 111 controls overall process via the connection manager 112. Specifically, the connection manager 112 checks whether or not a currently available external controller exists via the connectivity framework 120 and checks an available virtual controller type via the controller type storing unit (type DB) 113 (2. Search for external/virtual controller). The abovementioned procedure corresponds to the step of S210 mentioned earlier in FIG. 3.

If an available external controller and/or a virtual controller are checked, the connection manager 112 informs a user of the available external controller and/or the virtual controller via the display means 17. Subsequently, a controller determined by the selection of the user is executed (3. Select a controller by a user). The abovementioned procedure corresponds to the steps of S220 and S230 mentioned earlier in FIG. 3.

According to the present invention, if the abovementioned procedure is performed, it may be able to additionally provide various types of virtual controllers to a user via the mobile device 10 without modifying the legacy VR app 162. The procedure enables a user to more efficiently use the VR device 20.

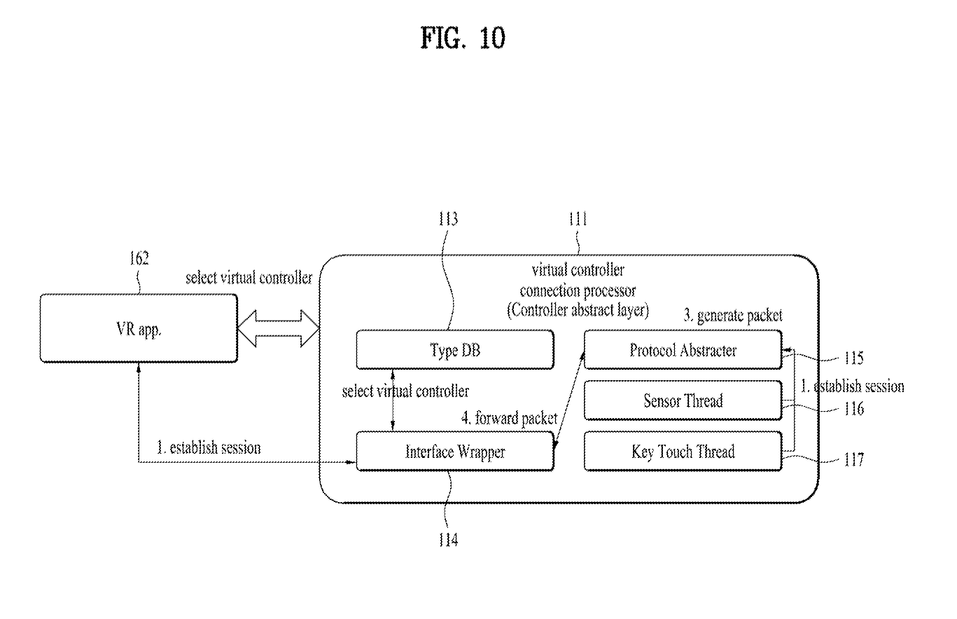

FIG. 9 is a diagram for a procedure of selecting and executing an external controller 41/42 by the virtual controller connection processor 111 according to an embodiment of the present invention. If the external controller is selected by a user, as mentioned in the foregoing description, the external controller connection process 400 mentioned earlier in FIG. 9 is performed according to a legacy general scheme. If the connection process 400 is implemented according to the legacy scheme, it may indicate that compatibility for using the VR app 162 without modifying the VR app is provided. In particular, for example, in case of a VR app 162 of Android scheme, a state capable of performing communication with the external controller 41/42 is maintained via a connectivity framework 120 and a hardware connection program (hardware abstract layer) 121.

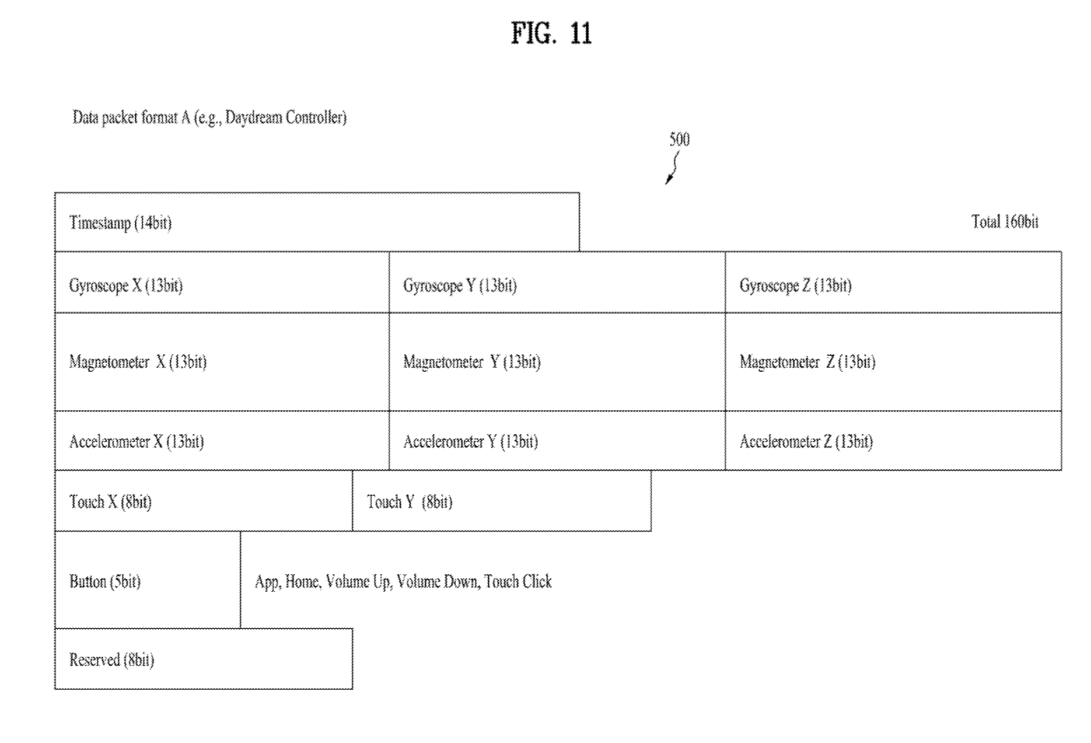

FIG. 10 is a diagram for a procedure of selecting and executing a virtual controller by the virtual controller connection processor 111 according to an embodiment of the present invention. If the virtual controller is selected by a user, a virtual controller connection process 300 is executed shown in FIG. 10. Specifically, the interface unit (interface wrapper) 114 maintains a communication session with the executed VR app 162 (1. Session connection). The sensor sensing unit (sensor thread) 116 and the touch sensing unit (key touch thread) 117 collect input data appropriate for a type of the selected virtual controller and transmit the data to the packet generating unit (protocol abstracter) 115 (2. Data collection). The packet generating unit (protocol abstracter) 115 generates a data packet in a manner of matching the input data collected by the sensor sensing unit (sensor thread) 116 and the touch sensing unit (key touch thread) 117 with a predetermined data format according to a type of the selected virtual controller (3. Packet generation). The generated data packet is forwarded to VR app 162 via the interface unit (interface wrapper) 114 and the data packet is used for controlling the connected VR device 20. As mentioned in the foregoing description, FIGS. 11 and 12 show an example of a data packet format which is generated according to the predetermined data format of the virtual controller type.

The present invention can be implemented with a code readable by a computer in a media in which a program is recorded. The media readable by the computer includes all kinds of recording devices in which data readable by a computer system are stored. The examples of the recording media readable by the computer may include a HDD (hard disk drive), an SSD (solid state disk), an SDD (silicon disk drive), a ROM, a RAM, a CD-ROM, a magnetic tape, a floppy disc, an optical data storing device and the like. And, implementing in a form of a carrier wave (e.g., transmission via the internet and the like) is also included. And, the computer can include the control unit 11 of the mobile device. While the present specification has been described and illustrated herein with reference to the preferred embodiments and diagrams thereof, the present specification may be non-limited to the aforementioned embodiments and it will be apparent to those skilled in the art that various modifications and variations can be made therein without departing from the spirit and scope of the present specification. Thus, it is intended that the present specification covers the modifications and variations of this invention that come within the scope of the appended claims and their equivalents.

What is claimed is:

1. A method of driving a virtual reality (VR) device controller, comprising the steps of:
executing a VR application (VR app) for driving a VR device;
driving a controller connection processor interlocked with the VR app;
selecting either an external controller or a virtual controller as a controller for driving the VR device via the controller connection processor; and
if the virtual controller is selected, performing communication with the VR device by generating a data packet corresponding to the selected virtual controller.

2. The method of claim 1, if the external controller is selected, further comprising the step of controlling the selected external controller to be connected via wireless communication.

3. The method of claim 1, further comprising the step of visually providing information on an available external controller and a virtual controller provided by the controller connection processor.

4. The method of claim 1, if the virtual controller is selected, further comprising the step of providing a virtual controller user manual provided by the controller connection processor.

5. The method of claim 4, wherein the controller user manual is provided in a manner of being overlaid with a background screen.

6. The method of claim 1, wherein the controller connection processor is configured using a controller connection program (controller abstract layer).

7. A mobile device, comprising:
a memory configured to store a virtual reality application (VR app) for driving a virtual reality device (VR device); and
a control unit containing a controller connection processor interlocked with the VR app, the control unit configured to select either an external controller or a virtual controller as a controller for driving the VR device via the controller connection processor, the control unit, if the virtual controller is selected, configured to control communication with the VR device to be performed by generating a data packet corresponding to the selected virtual controller.

8. The mobile device of claim 7, if the external controller is selected, further comprising a short distance communication means capable of performing wireless communication with the selected external controller.

9. The mobile device of claim 7, further comprising a display means for visually providing information on an available external controller and a virtual controller.

10. The mobile device of claim 9, wherein if the virtual controller is selected, the control unit is configured to provide a virtual controller user manual via the display means.

11. The mobile terminal of claim 10, wherein the controller user manual is provided in a manner of being overlaid with a background screen.

12. The mobile terminal of claim 10, wherein the controller connection processor is configured using a controller connection program.

13. The mobile terminal of claim 12, wherein the controller connection program comprises a virtual controller type storing unit configured to store at least one or more virtual controllers, an interface unit configured to perform a process of establishing a session with the VR app by selecting an interface appropriate for a type of a connected virtual controller, and a packet generating unit configured to generate a data packet according to a protocol appropriate for the type of the connected virtual controller.

14. The mobile terminal of claim 13, wherein the controller connection program further comprises a sensor sensing unit configured to collect sensor data appropriate for the type of the connected virtual controller and a touch sensing unit configured to collect an input touch data appropriate for the type of the connected virtual controller.

15. A VR (virtual reality) display system, comprising: a tethered VR device containing a VR display means;
a mobile device configured to control a VR display in a manner of being connected with the VR device; and
a controller configured to control the VR device to be driven,
wherein the controller comprises either a virtual controller provided within the mobile device or an external controller physically separated from the mobile device and wherein the mobile device comprises a controller connection processor configured to select either the virtual controller or the external controller as a controller.
